(19) United States
(12) Patent Application Publication
(10) Pub. No.: US 2016/0267290 A1
(43) Pub. Date: Sep. 15, 2016

(54) INFORMATION VIEWING METHOD, DEVICE, SYSTEM AND STORAGE MEDIUM

(71) Applicant: TENCENT TECHNOLOGY (SHENZHEN) COMPANY LIMITED, Shenzhen (CN)

(72) Inventors: XIANG GAN, Shenzhen (CN); YIFAN ZHOU, Shenzhen (CN); XIAORONG SHI, Shenzhen (CN)

(21) Appl. No.: 15/161,616

(22) Filed: May 23, 2016

Related U.S. Application Data
(63) Continuation of application No. PCT/CN2014/091196, filed on Nov. 14, 2014.

(30) Foreign Application Priority Data
Nov. 21, 2013 (CN) 2013-10594727.2

(51) Int. Cl. G06F 21/62; H04L 29/06; G06F 17/30

(52) U.S. Cl. CPC G06F 21/6218; G06F 17/30867; G06F 17/30554; H04L 63/102

(57) ABSTRACT

An information viewing method, relative device, system, and storage medium are provided. The method includes: sending, by a first server, an interactive message comprising a searching instruction to a second server when receiving the searching instruction sent by a client; searching for, by the second server, corresponding target information according to a configured searching permission corresponding to the user information in the searching instruction, generating a searching link address associated with a storage address of the target information and sending the generated searching link address to the first server; returning, by the first server, the searching link address to the client; and presenting, by the second server, the corresponding target information when receiving a viewing request. In embodiments of the present invention, relative information can be viewed legally, and the information can be managed effectively, which protect internal information of the business entity and personal private information well.

### CROSS-REFERENCE TO RELATED APPLICATION

This application claims priority to a Chinese patent application No. 201310594727.2 filed on Nov. 21, 2013 by Shenzhen Tencent Computer System Co., Ltd. and entitled “INFORMATION VIEWING METHOD, DEVICE AND SYSTEM”, the content of which is incorporated herein by reference in its entirety.

### TECHNICAL FIELD

The present disclosure generally relates to the field of information technologies and, in particular, relates to an information viewing method, device, system and storage medium.

### BACKGROUND

In the current informationalized society, a user can communicate with others through communication devices or other user devices for the purpose of information exchanges and intercommunications anytime and anywhere, and the user can obtain and view information such as chatting records, which is generated during the information communications between the users, according to the user account and password of the user which were used in the information communications, if necessary. Furthermore, some relatively important information or private information of users can be preserved in a cloud storage server and provided to the users for viewing through various devices, which provides convenience for the users.

With the existing information viewing methods, any user can directly view chatting records and even other private information from a server according to the corresponding user account and password of the user. In this case, the server sends related information as per a viewing request to a client initiating the viewing request, so that the user can view the information. Although the user's demand to view the related information is satisfied, problems still exist, for those information that is already sent but cannot be effectively managed by the server, and information security vulnerabilities exist.

### SUMMARY

The technical problems to be resolved by embodiments of the present invention are to provide an information viewing method, device and system and a storage medium to ensure effective management on relevant information during information enquiry.

An information viewing method is provided according to embodiments of the present invention to solve previous technical problems, which includes following steps:

sending, by a first server, an interactive message including a searching instruction to a second server when receiving the searching instruction sent by a client, wherein the searching instruction contains user information;

searching for, by the second server, corresponding target information according to a configured searching permission corresponding to the user information in the searching instruction, generating a searching link address associated with a storage address of the target information and sending the generated searching link address to the first server;

returning, by the first server, the searching link address to the client; and

presenting, by the second server, the corresponding target information when receiving a viewing request, wherein the viewing request is generated according to an access request that is initiated by the client according to the searching link address.

Another information viewing method is provided according to embodiments of the present invention, which includes:

performing identity verification on user information contained in a searching instruction when receiving a message including the searching instruction that is sent by a client based on a user login account;

obtaining a searching link address if the identity verification on the user information is passed, wherein the searching link address is associated with a storage address of target information searched out according to the searching instruction; and

returning the searching link address to the client to allow the client to view the target information through the client according to the searching link address.

Another information viewing method is provided according to embodiments of the present invention, which includes:

receiving an interactive message sent by the communication server, wherein the interactive message includes a searching instruction containing user information;

searching for corresponding target information according to a configured searching permission corresponding to the user information contained in the searching instruction, generating a searching link address associated with a storage address of the target information and sending the generated searching link address to the communication server such that the communication server returns the searching link address to a client sending the searching instruction; and

presenting the corresponding target information when a viewing request is received, wherein the viewing request is generated according to an access request that is initiated by the client according to the searching link address.

Accordingly, an information viewing device is provided according to embodiments of the present invention, which includes:

a verifying module, configured to perform identity verification on user information contained in a searching instruction when a message including the searching instruction sent by a client based on a user login account is received;

an obtaining module, configured to obtain a searching link address if the identity verification on the user information is passed, wherein the searching link address is associated with a storage address of a target information searched out according to the searching instruction; and

a responding module, configured to return the searching link address to the client to allow the client to view the target information through the client according to the searching link address.

An information viewing device is further provided according to embodiments of the present invention, which includes:

a receiving module, configured to receive an interactive message including a searching instruction sent by a communication server, wherein the searching instruction contains user information;

a processing module, configured to search for corresponding target information according to a configured searching permission corresponding to the user information in the searching instruction, generating a searching link address associated with a storage address of the target information and sending the searching link address to the communication server such that the communication server returns the searching link address to a client sending the searching instruction; and

a presenting module, configured to present the corresponding target information when a viewing request is received, wherein the viewing request is generated according to an access request that is initiated by the client according to the searching link address.

Accordingly, an information viewing system is also provided according to embodiments of the present invention, which includes: a client, a first server and a second server, wherein the client is a user equipment;

the first server is configured to send an interactive message including a searching instruction to the second server upon receiving the searching instruction sent by the client;

the second server is configured to search for corresponding target information according to a configured searching permission corresponding to the user information in the searching instruction, generate a searching link address associated with a storage address of the target information and send the searching link address to the first server;

the first server is further configured to return the searching link address to the client; and

the second server is further configured to present the corresponding target information upon receiving a viewing request, wherein the viewing request is generated according to an access request that is initiated by the client according to the searching link address.

A storage medium including computer-executable instructions, wherein the computer-executable instructions are configured to perform an information viewing method when being executed by a computer processor, and the method includes:

sending, by a first server, an interactive message comprising a searching instruction to a second server when receiving the searching instruction sent by a client, wherein the searching instruction contains user information;

searching for, by the second server, corresponding target information according to a configured searching permission corresponding to the user information in the searching instruction, generating a searching link address associated with a storage address of the target information and sending the generated searching link address to the first server;

returning, by the first server, the searching link address to the client; and

presenting, by the second server, the corresponding target information when receiving a viewing request, wherein the viewing request is generated according to an access request that is initiated by the client according to the searching link address.

In embodiments of the present invention, after a viewing instruction to view corresponding information is initiated by a user, a link address is returned if authentication and verification is successfully passed, and target information searched out is stored at the server side such that the information can also be effectively managed while allowing the authorized user to view relative information, for example, the information can be deleted after being viewed by the user for a while or be prevented from leakage through other management measurements, thereby protecting internal information of a company and a business entity, and protecting personal private information.

### BRIEF DESCRIPTION OF THE DRAWINGS

In order to clearly describe technical solutions according to embodiments of the present invention or in the prior art, necessary accompanying drawings used for the description of the embodiments of the present invention or the prior art will be briefly introduced below, apparently, the drawings described below illustrate merely some of embodiments of the present invention, and other drawings can be obtained from those accompanying drawings by a skilled person in the art without any creative work.

FIG. 1 is a flow chart of an information viewing method according an embodiment of the present invention;

FIG. 2 is a flow chart of another information viewing method according an embodiment of the present invention;

FIG. 3 is a flow chart of still another information viewing method according an embodiment of the present invention;

FIG. 4 is a flow chart of still another information viewing method according an embodiment of the present invention;

FIG. 5 is a schematic structure view showing an information viewing system according to an embodiment of the present invention;

FIG. 6 is a schematic structure view showing another information viewing system according to an embodiment of the present invention;

FIG. 7 is a schematic structure view showing of an information viewing device according to an embodiment of the present invention;

FIG. 8 is a schematic view showing a structure of an obtaining module in the information viewing device illustrated in FIG. 7 according to an embodiment of the present invention;

FIG. 9 is a schematic structure view showing of another information viewing device according to an embodiment of the present invention;

FIG. 10 is a schematic view showing a structure of a processing module in the information viewing device illustrated in FIG. 9 according to an embodiment of the present invention;

FIG. 11 is a schematic view showing a structure of a presenting module in the information viewing device illustrated in FIG. 9 according to an embodiment of the present invention; and

FIG. 12 illustrates an exemplary computer system consistent with various disclosed embodiments.

### DETAILED DESCRIPTION OF THE EMBODIMENTS

The technical solutions according to embodiments of the present invention will be clearly and completely described below with reference to the accompanying drawings in the embodiments of the present invention. Apparently, the described embodiments are merely a part of embodiments of the present invention but not all of the embodiments. Other embodiments obtained by the skilled person in the art without creative work based on the described embodiments of the present invention all fall within the scope claimed by the present disclosure.

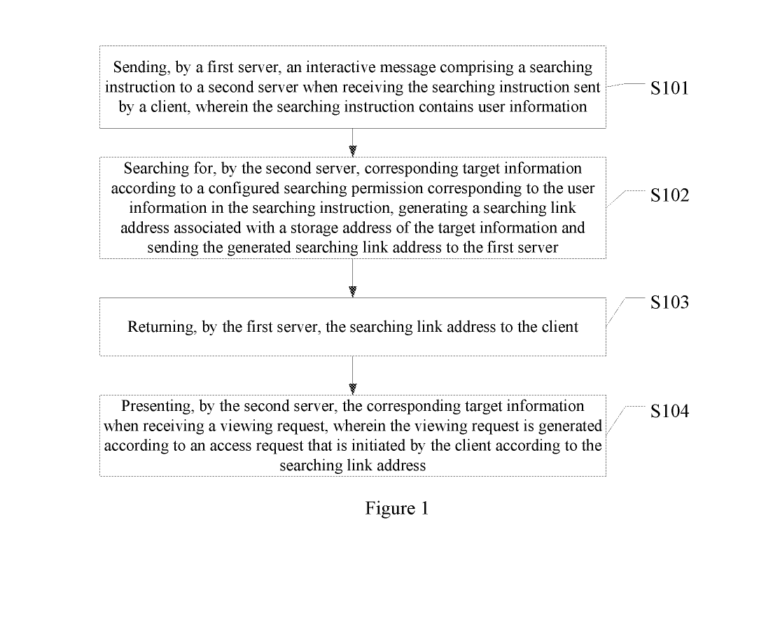

As illustrated in FIG. 1 which is a flow chart of an information viewing method according an embodiment of the present invention, the method according to the embodiment of the present invention can be embodied among user equipments, an application server for an instant messaging application, a social network communication application and the like and an information management server. Particularly, the method according to the present disclosure includes the following exemplary Steps S101, S102, S103 and S104 described below.

Step S101: an interactive message containing a searching instruction is sent by a first server to a second server when the first server receives the searching instruction from a client, where the searching instruction contains user information.

The information is communicated among the client, the first server and the second server based on the corresponding registered user account. The first server may be an application server for an instant messaging application, a social network communication application and the like, and the client includes corresponding instant messaging applications, social network communication applications and the like, so that the user can directly initiate a searching instruction for a specified user account (for example, a public account set for information management).

The searching instruction sent for the designated user account by the user through the client may be included in a normal instant messaging message, which is subsequently directly sent by the first server to the second server, and the content of the instant messaging message is verified and responded to, by the second server. For example, when a user needs to search for information such as chatting records, stored photos, bank card accounts and passwords and the like from a server (e.g., the second server) for information management, a searching instruction is sent to the instant messaging application server (e.g., the first server) based on an instant messaging application, and the searching instruction is transmitted by the first server to the second server to search for corresponding information.

The searching instruction sent for a designated user account by a user through a client can be an instant messaging message in a negotiating format such as a message in a format with security (sec) information and user information. When an instant messaging message in such format sent for the specific user account is received by the first server, the instant messaging message is distinguished from normal messages, the content of the instant messaging message is identified and verified, and then the instant messaging message is sent to the second server if the verification is successfully passed.

Alternatively, the instant messaging message including a searching instruction may be sent for a specific user account (e.g., a registered account dedicated in information searching) by the client and subsequently distinguished from normal messages by the first server, the content of the instant messaging message may be identified and verified, and then the instant messaging message is sent to the second server if the verification is passed.

Step S102: corresponding target information is searched for by the second server according to a configured searching permission corresponding to the user information in the searching instruction, a searching link address related to a storage address of the target information is generated and sent to the first server.

The second server may determine the configured searching permission corresponding to the user information in the searching instruction according to a preset whitelist including mapping relationships between users and searching permissions, and then search for corresponding information based on the determined searching permission.

In the present embodiment, the corresponding target information searched out according to the configured searching permission corresponding to the user information in the searching instruction includes: personal private information stored for user information registration in the second server. That is, for an individual user, the target information includes private confidential information searched out according to a phone number of the user, an account for an instant messaging application and/or other user information. For example the private confidential information includes a bank card account and a password or contact information of relatives of the user.

It is noted that in the present embodiment, the searching instruction may also include indication information for indicating the content to be searched, so that when the searching permission of the user is determined by the second server, the content indicated by the indication information is searched by the second server, where the specific content and the format of the searching instruction can be configured according to various management rules applied in an information management server.

After target information such as corresponding chatting records are searched out by the second server, the target information is not returned to the first server, but a short link is generated according to a storage address of the target information and returned to the first server from the second server. It is noted that the short link is not an actual storage address of the target information, but an association relationship between the short link and the storage address of the target information is established by the second server, so that corresponding target information can be searched out by the second server based on the association relationship when a viewing request is initiated by a client subsequently. The association relationship can be deleted or canceled by the second server at any time.

Step S103: the searching link address is returned to the client by the first server.

Step S104: the corresponding target information is presented at the second server when a viewing request is received by the second server, where the viewing request is generated according to an access request that is initiated by the client according to the searching link address.

After the searching link address (e.g., the short link described above) returned by the first server is received by the client, an access request may be initiated through clicking on the client, in this case, when an operation of clicking the searching link address is detected by the client, a viewing request is initiated through an invoked browser and the target information is displayed to the user after being loading into the browser.

It may be a web server configured for a specific network to generate the viewing request according to the access request, the web server is controlled by the second server to start, and to close after the presented information is viewed by the user, particularly, the web server may be closed after a preset time threshold (which may be five minutes, for example) or after the web server is accessed by the user.

Furthermore, in the present embodiment, searching for internal confidential information of a company or a business entity can be achieved by the present embodiment of the present invention. The corresponding target information searched out according to a configured searching permission corresponding to the user information in the searching instruction includes: internal confidential information that is already registered and stored in the second server and available for searching by users corresponding to the user information, e.g. internal confidential information of a company or a business entity including contact information of staffs, payrolls and revenues of the company or business entity.

In the present embodiment of the present invention, after a viewing instruction to view corresponding information is initiated by a user, a link address is returned if authentication and verification is passed, and the target information searched out is still stored at the server side such that the information can be effectively managed while allowing the authorized user to view related information, for example, the information can be deleted after being viewed by the user for a while or be prevented from leakage through other management measurements, thereby protecting internal information of the company and business entity and personal private information.

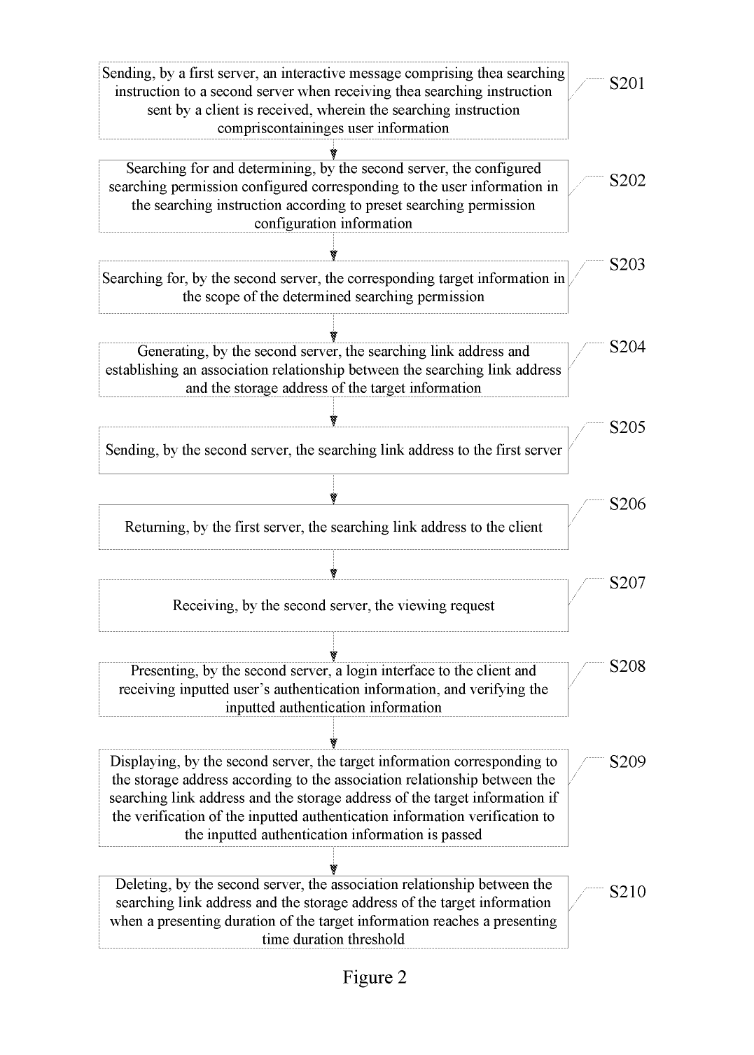

As illustrated in FIG. 2 which is a flow chart of another information viewing method according an embodiment of the present invention, the method according to the embodiment of the present invention can be embodied among a user equipment, an application server for an instant messaging application, a social network communication application and the like and a server for information management. Particularly, the method according to the present disclosure includes the following Steps S201 to S210.

Step S201: an interactive message including a searching instruction is sent by a first server to a second server when the searching instruction is received by the first server from a client, where the searching instruction includes user information.

If a user wishes to search for information such as chatting records, stored photos, bank card accounts and passwords and the like, a searching instruction may be initiated by the user via an instant messaging application to a corresponding application server, e.g., the first server.

The client, the first server and the second server communicate with each other based on the corresponding registered user account. In the present embodiment, the instant messaging message with a negotiating format or a specific user account may be used to distinguish from an instant messaging message from a normal user by the first server. When determining a received instant messaging message as an instant messaging message carrying a searching instruction to search for relative information for some specific user account (for example, a public account set for information management) based on a format of the instant messaging message or the user account, the first server conducts identity verification on user information in the searching instruction, and sends an interactive message containing the searching instruction to the second server if the identity verification of the user information is passed.

Step S202: the configured searching permission corresponding to the user information in the searching instruction is searched and determined by the second server according to preset searching permission configuration information.

The second server, which may be a cloud storage server for example, stores information such as the above-mentioned chatting records, stored photos, bank card accounts and passwords. The searching permission can be determined according to a whitelist set for corresponding information at the second server.

Step S203: corresponding target information is searched by the second server in the scope of the determined searching permission.

Step S204: the second server generates a searching link address and establishes an association relationship between the searching link address and the storage address of the target information.

The preset searching permission configuration information may be a map table which is used to determine the searching permission of a user. The searching instruction may also include indication information for indicating the content to be searched, so that when the searching permission of the user is determined by the second server, the content indicated by the indication information is searched by the second server, where the specific content and the format of the searching instruction can be configured according to various management rules applied in an information management server.

The searching link address is associated with the storage address of the target information stored in the second server, so that the target information corresponding to the storage address can be presented to a user according to the association relationship between the searching link address and the storage address of the target information when an access request is initiated by the user according to the searching link address. That is, the searching link address is not an actual address of the target information in the second server, and after the target information is viewed by the user, the association relationship can be deleted by the second server at any time if necessary, and then the target information associated with the searching link address cannot be viewed anymore, for example, the association relationship can be deleted after a preset time threshold (which may be five minutes, for example) or can be deleted after a preset time threshold (which is five minutes, for example) following a first clicking operation of the user, or can be deleted immediately after the user initiates the access request and views the target information.

Step S205: the searching link address is sent to the first server by the second server.

The previous Steps S202 to S204 may correspond to Step S102 in the embodiment illustrated in FIG. 1.

The second server may perform a response limitation process on the target information at any time after the target information is searched out, particularly, a response limitation process is performed on the target information by the second server according to preset operation response strategies which include: a strategy of refusing to respond to a copy request from the client, a strategy of refusing to respond to a right-click menu request from the client and a strategy of blocking web spiders from a searching engine.

Meantime, a web function of a third server (e.g., a server for possessing a web function) which is generally not open to public may be triggered by the second server, and the third server receives the access request sent from the client and generates a viewing request according to the access request, so that corresponding target information is presented when the viewing request is received by the second server. That is, the viewing request is generated by the third server, and before that corresponding target information is presented by the second server upon receiving the viewing request, the web function of the third server is triggered and initiated by the second server, the access request initiated by the client according to the searching link address is received by the third server, a viewing request is generated by the third server according to the access request, and the viewing request is sent from the third server to the second server.

Step S206: the searching link address is returned to the client by the first server.

Step S207: the viewing request is received by the second server.

When the searching link address returned by the first server is received by the client, an access request to view the corresponding information such as chatting records in the second server is initiated to the third server through an invoked browser by a clicking operation of the user, and a viewing request is generated and sent to the second server by the third server which is triggered by the second server.

Step S208: the second server presents a login interface to the client and receives inputted user authentication information, and then verifies the inputted authentication information.

Step S209: the target information corresponding to the storage address is displayed by the second server according to the association relationship between the searching link address and the storage address of the target information if the verification of the inputted authentication information is passed. In displaying the target information corresponding to the storage address, the second server may stamp a watermark including a user identifier from the authentication information of the user onto the target information to be displayed and display the target information with the stamped watermark.

Previous Steps S207 to S209 may correspond to Step S103 in the embodiment illustrated in FIG. 1. In the present embodiment of the present invention, before the target information is viewed by the user through the client according to the searching link address, further verification may be performed by the server by requiring the user to input user information and password, to ensure the safety of the target information. After the correct user information and password are input by the user, an image including the target information and the user information as a watermark is generated by the server according to the target information and the user information, so that the source of leaking the target information can be tracked if the target information is leaked through taking a picture of the image or a screen shot to the image.

Step S210: the established association relationship between the searching link address and the storage address of the target information is deleted by the second server when the second server detects that the presenting duration of the target information reaches a predefined presenting duration threshold.

After the association relationship between the searching link address and the storage address of the target information is deleted, the searching link address is invalid, and when a viewing request is initiated according to the searching link address by any user, no response would be received from the second server and the third server.

In the present embodiment, the second server may preset the presenting duration threshold according to the system time of the second server and data volume of the target information, and present the presenting duration threshold to the user. For example, while sending the searching link address, the server sends a tip “this search link address will be invalid in five minutes” as well, and after the viewing request is initiated by the user, the server deletes the established association relationship between the searching link address and the storage address of the target information after the presenting duration threshold is reached, as thus, the target information cannot be viewed anymore by the user according to the received searching link address. By deleting the association relationship, the target information is protected from being viewed by an illegal user through the searching link address when the user equipment is lost or stolen.

In other embodiments of the present invention, to further protect the target information, the second server controls the third server to shut down the web function when detecting that a presenting duration of the target information reaches a presenting duration threshold; or the second server deletes the association relationship between the searching link address and the storage address of the target information after receiving the viewing request and presenting the corresponding target information.

Furthermore, in the present embodiment, searching for internal confidential information of a company or a business entity can be achieved by the present embodiment of the present invention. The corresponding target information searched out according to a configured searching permission corresponding to the user information in the searching instruction includes: internal confidential information that is already registered and stored in the second server and available for searching by users corresponding to the user information, e.g. internal confidential information of a company or a business entity including contact information of staffs, payrolls and revenues of the company or business entity.

In the present embodiment, after a viewing instruction to view corresponding information is initiated by a user, a link address is returned if authentication and verification is passed, and the target information searched out is still stored at the server side such that the information can be effectively managed while allowing the authorized user to view related information, for example, the information can be deleted after being viewed by the user for a while or be prevented from leakage through other management measurements, thereby protecting various target information.

Furthermore, the time threshold is set for facilitating the deletion of the association relationship between the searching link address and the storage address of the target information, and a watermark including a user identifier is stamped, so that the leakage of the target information can be prevented to some extent in a safe and convenient way.

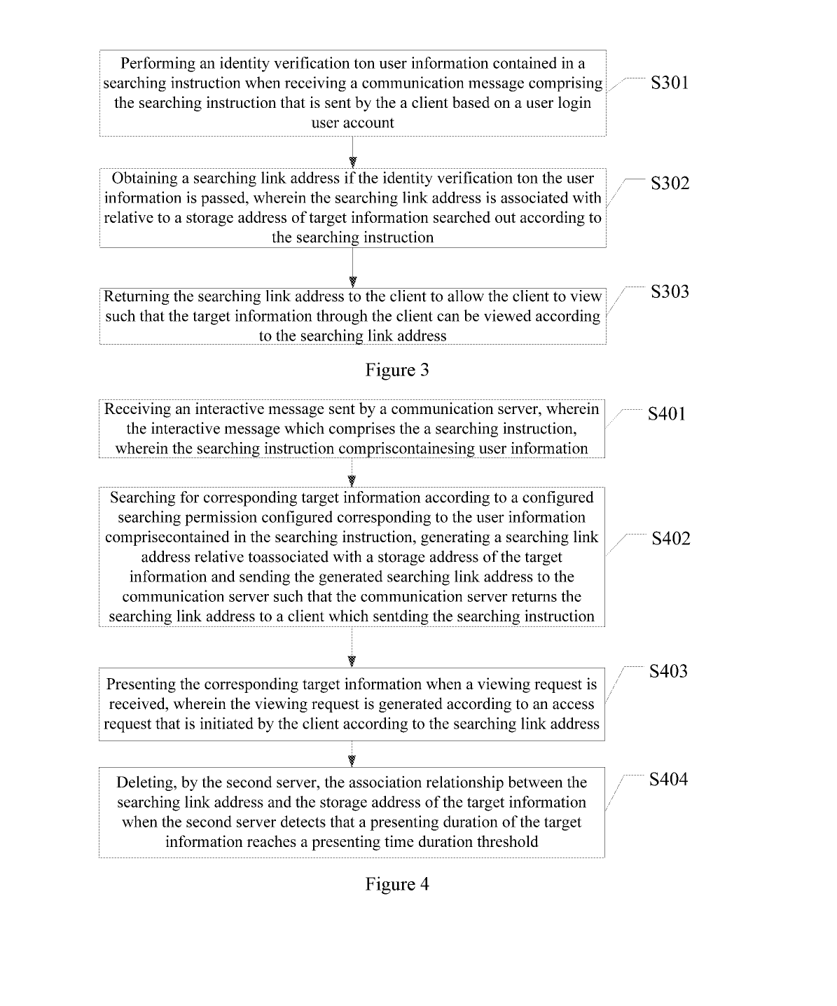

As illustrated in FIG. 3 which is a flow chart of still another information viewing method according an embodiment of the present invention, the method according to the embodiment of the present invention can be embodied among an application server for an instant messaging application, a social network communication application and the like. Particularly, the method according to the present disclosure includes the following Steps S301 to S303:

Step 301, identity verification is performed on user information contained in a searching instruction when a communication message including the searching instruction that is sent by a client based on a user login account is received.

Step S302, a searching link address is obtained if the identity verification on the user information is passed, where the searching link address is associated with a storage address of a target information searched according to the searching instruction.

The searching instruction is sent by a user through the client and relative communication server, the searching instruction is used to search for information such as chatting records, stored photos, bank card accounts and passwords and the like, stored in the server.

In the present embodiment, the relative server may be configured to be a server which is able to perform functions such as searching for target information and security management. After the identity verification on the user information is passed, the searching link address may be generated based on the same way performed by the second server in the embodiments illustrated in FIGS. 2 and 3. Or, the relative sever according to the present embodiment may obtain the searching link address from the second server in the embodiments illustrated in FIGS. 2 and 3, in this regard, step S302 includes following steps: an interactive message including the searching instruction is sent to a searching server if the identity verification on the user information is passed; and the searching link address returned by the searching server is received, and the searching link address is generated by the searching server according to the target information searched out in response to the searching instruction and the storage address of the target information. The searching server may be the second server.

Step S303, the searching link address is returned to the client to allow the client to view the target information through the client according to the searching link address.

An access request may be initiated by the client according to the searching link address through a browser, and information, such as chatting records, stored photos, bank card accounts and passwords and the like, are displayed for the user through the browser by way of displaying images.

In the present embodiment, a server configured to perform the method according to the present embodiment may be the first server in the embodiments illustrated in FIGS. 1 and 2, the implementation of the method including steps S301 to S303 in the present embodiment refers to the description of the first server in the embodiments illustrated in FIGS. 1 and 2, which is not repeated herein.

Furthermore, in the present embodiment, searching for internal confidential information of a company or a business entity can be achieved by the present embodiment of the present invention. The corresponding target information searched out according to a configured searching permission corresponding to the user information in the searching instruction includes: internal confidential information that is already registered and stored in the second server and available for searching by users corresponding to the user information, e.g. internal confidential information of a company or a business entity including contact information of staffs, payrolls and revenues of the company or business entity.

In the present embodiment of the present invention, after a viewing instruction to view corresponding information is initiated by a user, a link address is returned if authentication and verification is passed, and the target information searched out is still stored at the server side such that the information can be effectively managed while allowing the authorized user to view related information, for example, the information can be deleted after being viewed by the user for a while or be prevented from leakage through other management measurements, thereby protecting various internal information.

As illustrated in FIG. 4 is a flow chart of still another information viewing method according an embodiment of the present invention, the method according to the embodiment of the present invention can be embodied in an information management server. Particularly, the method according to the present disclosure includes steps S401 to S404:

Step S401, an interactive message sent by a communication server is received, where the interactive message includes a searching instruction containing user information; the communication server is the first server described above, the procedure for the communication server to send the interactive message including the searching instruction refers to the description of the first server in the embodiment of the method described above.

Step S402, corresponding target information is searched for according to a configured searching permission corresponding to the user information contained in the searching instruction, a searching link address associated with a storage address of the target information is generated and sent to the communication server such that the communication server returns the searching link address to a client sending the searching instruction.

Step S402 may particularly include following steps: the configured searching permission corresponding to the user information in the searching instruction is searched and determined according to preset searching permission configuration information; corresponding target information is searched in the scope of the determined searching permission; a searching link address is generated and an association relationship between the searching link address and the storage address of the target information is established; and the searching link address is sent to the communication server.

Step S403, corresponding target information is presented when a viewing request is received, and the viewing request is generated according to an access request that is initiated by the client according to the searching link address.

An access request may be initiated by the client according to the searching link address through a browser, and information, such as chatting records, stored photos, bank card accounts and passwords and the like, are presented to the user through the browser by way of displaying images.

Step S403 may particularly include following steps: the viewing request is received; a login interface is presented to the client and inputted user's authentication information is received, and the inputted authentication information is verified; the target information corresponding to the storage address is displayed according to the association relationship between the searching link address and the storage address of the target information if the authentication information verification on the inputted authentication information is passed. When the target information corresponding to the storage address is displayed, a watermark including a user identifier from the authentication information of the user is stamped onto the target information to be presented and the target information with the stamped watermark is displayed.

Step S404, the association relationship between the searching link address and the storage address of the target information is deleted when a presenting duration of the target information is detected to reach a presenting duration threshold.

In the present embodiment, the server configured to perform the method may particularly be the second server described in the embodiments illustrated in FIG. 1 and FIG. 2, the implementation of the method including steps S401 to S403 in the present embodiment refers to the description of the second server in the embodiments illustrated in FIGS. 1 and 2., which is not repeated herein.

In other embodiments of the present invention, other manners can be adopted, for example, the third server is controlled by the second server to shut down the web function when the second server detects that a presenting duration of the target information reaches a presenting duration threshold; or the second server deletes the association relationship between the searching link address and the storage address of the target information after the second server receives the viewing request and presents the corresponding target information.

In the present embodiment, after a viewing instruction to view corresponding information is initiated by a user, a link address is returned if authentication and verification is passed, and the target information searched out is still stored at the server side such that the information can be effectively managed while allowing the authorized user to view related information, for example, the information can be deleted after being viewed by the user for a while or be prevented from leakage through other management measurements, thereby protecting internal information of the company and business entity and personal private information. Furthermore, the time threshold is set for facilitating the deletion of the association relationship between the searching link address and the storage address of the target information, and a watermark including a user identifier is stamped, so that the leakage of the target information can be prevented to some extent in a safe and convenient way.

The information viewing devices and system according to the embodiments of the present invention are described in detail below.

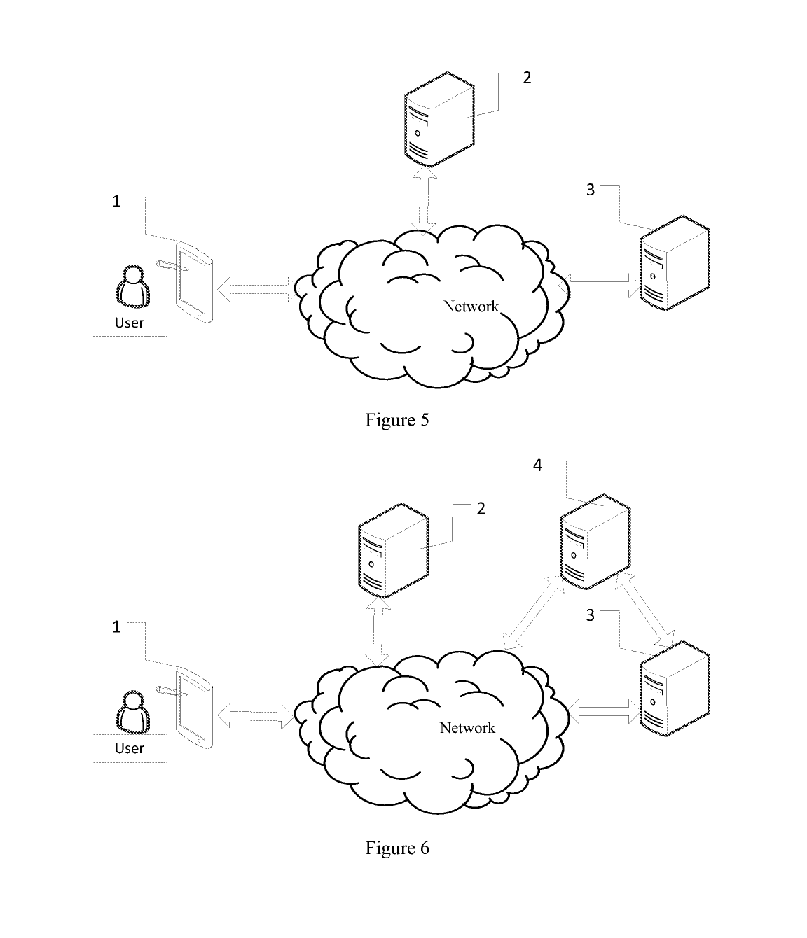

As illustrated in FIG. 5 which is a schematic structure view showing an information viewing system according to an embodiment of the present invention, the system according to an embodiment of the present invention includes: a client 1, a first server 2 and a second server 3, and the client is a user equipment;

the first server 2 is configured to send an interactive message including a searching instruction to the second server when a searching instruction sent by a client is received;

the second server 3 is configured to search for corresponding target information according to a configured searching permission corresponding to the user information in the searching instruction, generate a searching link address associated with a storage address of the target information and send the searching link address to the first server;

the first server 2 is further configured to return the searching link address to the client;

the second server 3 is further configured to present the corresponding target information when a viewing request is received, where the viewing request is generated according to an access request that is initiated by the client according to the searching link address.

The client may be a mobile terminal, such as a device with web function, which includes a telephone, a tablet personal computer and a smart wearable device, the mobile terminal, installed an applicable tool, such as an instant messaging application, a social network communication application in it, the first server 2 may be an application server for instant messaging applications, social network communication applications and the like, and the second server 3 may be an information management server (cloud server). The client 1, the first server 2 and the second server 3 may communicate with each other based on corresponding registered user account. The implementation of viewing information refers to descriptions of relative content in embodiments illustrated in FIG. 1 to FIG. 4, which is not repeated herein.

In the present embodiment, the corresponding target information searched out according to a configured searching permission corresponding to the user information in the searching instruction includes: personal private information registered and stored for the user information in the second server; or internal confidential information that is registered and stored in the second server and available for searching by a user corresponding to the user information. That is, for an individual user, the target information includes private confidential information searched out according to a phone number of the user, an account for an instant messaging application and other user information, for example the private confidential information includes a bank card account and a password or contact information of relatives of the user. And for a company or a business entity, the target information includes contact information of staffs, payrolls and revenues of the company or business entity.

Furthermore, as illustrated in FIG. 6 which is a schematic structure view showing another information viewing system according to an embodiment of the present invention, target information to be searched is stored in the third server 4, the third server 4 may particularly be a server configured to possess web function and may merely be controlled by the second server 3 to turn on/off the web function. And the second server 3 is also configured to trigger and initiate the web function of the third server 4; the third server 4 is configured to receive an access request sent by the client according to the searching link address; the third server 4 is also configured to generate a viewing request according to the access request and send the viewing request to the second server 3.

The searching link address is associated with the storage address of the target information stored in the second server, so that the target information corresponding to the storage address can be presented to a user according to the association relationship between the searching link address and the storage address of the target information when an access request is initiated by the user according to the searching link address. That is, the searching link address is not an actual address of the target information in the second server, and after the target information is viewed by the user, the association relationship can be deleted by the second server at any time if necessary, and then the target information associated with the searching link address cannot be viewed anymore, for example, the association relationship can be deleted after a preset time threshold (which may be five minutes, for example) or can be deleted after a preset time threshold (which may be five minutes, for example) following a first clicking operation of the user, or can be deleted immediately after the user initiates the access request and views the target information.

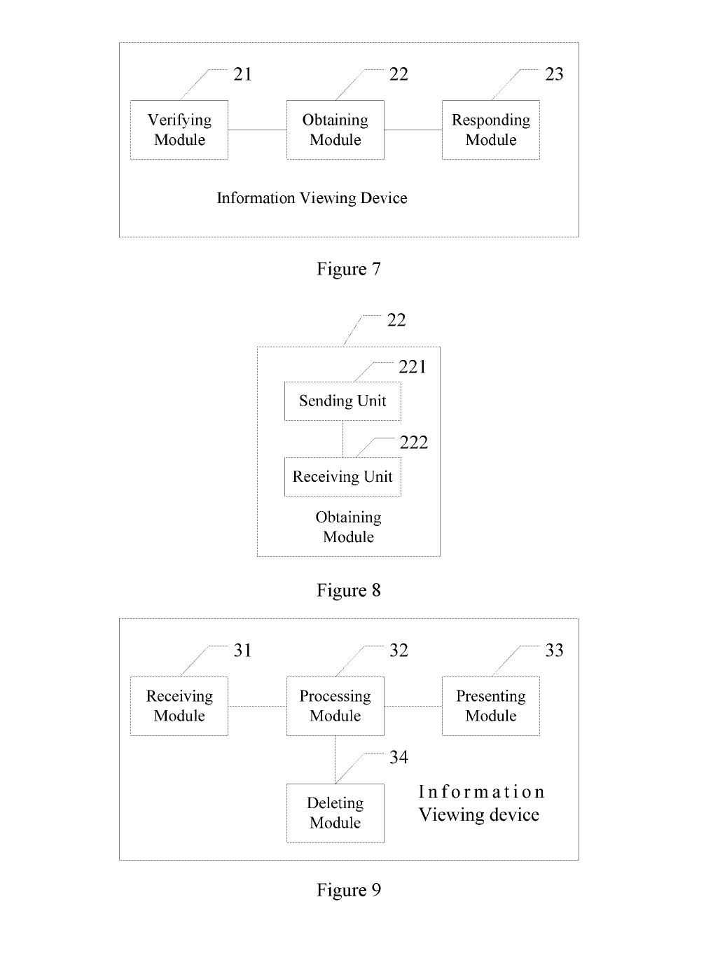

As illustrated in FIG. 7 which is a schematic structure view showing of an information viewing device according to an embodiment of the present invention, the information viewing device may be set in the second server 2 described above, the information viewing device includes a verifying module 21, an obtaining module 22 and a responding module 23:

the verifying module 21 is configured to perform identity verification on user information contained in a searching instruction when a message including the searching instruction sent by a client based on a user login account is received;

the obtaining module 22 is configured to obtain a searching link address if the identity verification on the user information is passed, where the searching link address is associated with a storage address of target information searched out according to the searching instruction; and

the responding module 23 is configured to return the searching link address to to allow the client to view the target information can be viewed through the client according to the searching link address through the client.

The server according to embodiments of the present invention may be configured to be a server which possesses functions of searching for target information and performing security management, and configured to obtain a searching link address by the obtaining module 22 based on the same manner of second server in the embodiments illustrated in FIG. 1 and FIG. 2 if the identity verification of the user is passed by the verification module 21.

Or, in the present embodiment, a searching link address may be obtained by the obtaining module 22 from the second server in the embodiments illustrated in FIG. 1 and FIG. 2 if the identity verification of the user is passed by verification module 21.

Optionally, as illustrated in FIG. 8, the obtaining module 22 may include a sending unit 221 and a receiving unit 222:

the sending unit 221 is configured to send the interactive message comprising the searching instruction to a searching server if the identity verification on the user information is passed; and

the receiving unit 222 is configured to receive the searching link address returned by the searching server, and the searching link address is generated by the searching server according to the target information searched out in response to the searching instruction and the storage address of the target information.

In the present embodiment, the searching server may be the second server; the implementation of obtaining the searching link address by the second server refers to the description of embodiments above.

In present embodiment of the invention, after a viewing instruction to view corresponding information is initiated by a user, a link address is returned if authentication and verification is passed, and target information searched out is stored at the server side such that the information can also be effectively managed while allowing the authorized user to view relative information, for example, the information can be deleted after being viewed by the user for a while or be prevent from leakage through other management measurements, thereby protecting internal information of the company and business entity and personal private information

As illustrated in FIG. 9 which is a schematic structure view showing of another information viewing device according to an embodiment of the present invention, the information viewing device according to the present embodiment may be set in the second server in the embodiments described above, the information viewing device includes a receiving module 31, a processing module 32, a presenting module 33 and a deleting module 34:

the receiving module 31 is configured to receive an interactive message comprising a searching instruction sent by a communication server, and the searching instruction comprises user information;

the processing module 32 is configured to search for corresponding target information according to a configured searching permission corresponding to the user information in the searching instruction, generating a searching link address associated with a storage address of the target information and sending the searching link address to the communication server such that the communication server returns the searching link address to a client sending the searching instruction;

the presenting module 33 is configured to present the corresponding target information when a viewing request is received, and the viewing request is generated according to an access request that is initiated by the client according to the searching link address.

The communication server may be the first server described above, the implementation of sending interactive messages including searching instruction by the first server refers to the corresponding description of the first server in above embodiments.

The processing module 32 may determine the configured searching permission corresponding to the user information in the searching instruction according to a preset whitelist including mapping relationships between users and searching permissions, and then search for corresponding information based on the determined searching permission. And in the present embodiment, the corresponding target information searched out according to a configured searching permission corresponding to the user information in the searching instruction includes: personal private information registered and stored for the user information in the second server; or internal confidential information that is registered and stored in the second server and available for searching by a user corresponding to the user information. That is, for an individual user, the target information includes private confidential information searched out according to a phone number of the user, an account for an instant messaging application and other user information, for example the private confidential information includes a bank card account and a password or contact information of relatives of the user. And for a company or a business entity, the target information includes contact information of staffs, payrolls and revenues of the company or business entity.

It is noted that in the present embodiment, the searching instruction may also include indication information for indicating the content to be searched, so that when the searching permission of the user is determined by the second server, the content indicated by the indication information is searched by the second server, where the specific content and the format of the searching instruction can be configured according to various management rules applied in an information management server.

After target information is searched out by processing module 32, the target information is not returned to the first server, but a short link is generated according to a storage address of the target information and returned to the first server from the second server. It is noted that the short link is not an actual storage address of the target information, but an association relationship between the short link and the storage address of the target information is established by the second server, so that corresponding target information can be searched out by the second server based on the association relationship when a viewing request is initiated by a client subsequently. The association relationship can be deleted or canceled by the second server at any time.

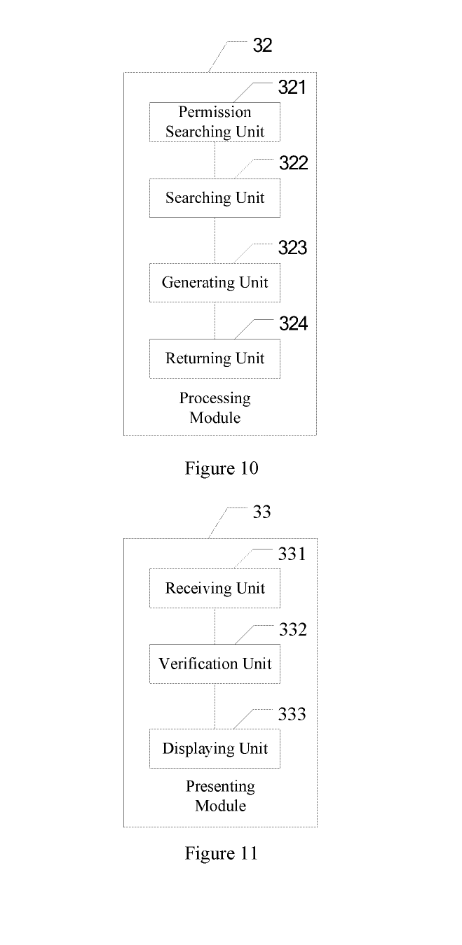

Furthermore, as illustrated in FIG. 10, the processing module 32 may particularly include a permission searching unit 321, a searching unit 322, a generating unit 323 and a returning unit 324:

the permission searching unit 321 is configured to search for and determine the configured searching permission corresponding to the user information in the searching instruction according to preset searching permission configuration information;

the searching unit 322 is configured to search for corresponding target information in the scope of the determined searching permission;

the generating unit 323 is configured to generate a searching link address and establish an association relationship between the searching link address and the storage address of the target information; and

the returning unit 324 is configured to send the searching link address to the communication server.

Further, optionally, as illustrated in FIG. 9, the device also includes a deleting module 34:

the deleting module 34 is configured to delete the association relationship between the searching link address and the storage address of the target information when the second server detects that a presenting duration of the target information reaches a presenting duration threshold.

In the present embodiment, the device may also include: a shutting down module, which is configured to control the third server to shut down the web function when the second server detects that a presenting duration of the target information reaches a presenting duration threshold; or the deleting module 24 is also configured to delete the association relationship between the searching link address and the storage address of the target information after the second server receives the viewing request and presents the corresponding target information.

In the present embodiment, the server may preset the presenting duration threshold according to the system time of the second server and data volume of the target information, and present the presenting duration threshold to the user. For example, while sending the searching link address, the server sends a tip “this search link address will be invalid in five minutes” as well, and after the viewing request is initiated by the user, the server deletes the established association relationship between the searching link address and the storage address of the target information after the presenting duration threshold is reached, as thus, the target information cannot be viewed anymore by the user according to the received searching link address. By deleting the association relationship, the target information is protected from being viewed by an illegal user through the searching link address when the user equipment is lost or stolen.

Furthermore, as illustrated in FIG. 11, the presenting module 33 may include a receiving unit 331, a verification unit 332 and a displaying unit 333:

the receiving unit 331 is configured to receive a viewing request initiated by a client according to the searching link address;

the verification unit 332 is configured to present a login interface to the client and receive inputted user's authentication information, and verify the inputted authentication information; and

the displaying unit 333 is configured to display the target information corresponding to the storage address according to the association relationship between the searching link address and the storage address of the target information if the authentication information verification to the inputted authentication information is passed.

In the present embodiment, when the displaying unit 333 is used to display the target information corresponding to the storage address, it is also used to stamp a watermark comprising a user identifier from the authentication information of the user onto the target information to be displayed and displaying the target information with the stamped watermark when the target information corresponding to the storage address is displayed.

In the present embodiment of the present invention, after a viewing instruction to view corresponding information is initiated by a user, a link address is returned if authentication and verification is passed, and target information searched out is stored at the server side such that the information can also be effectively managed while allowing the authorized user to view relative information, for example, the information can be deleted after being viewed by the user for a while or be prevent from leakage through other management measurements, thereby protecting internal information of the company and business entity and personal private information

Furthermore, the time threshold is set for facilitating the deletion of the association relationship between the searching link address and the storage address of the target information, and a watermark including a user identifier is stamped, so that the leakage of the target information can be prevented to some extent in a safe and convenient way.

In light of the description of the above embodiments, it should be understood by the skilled person in the art that the present disclosure can be embodied by software and the necessary universal hardware, or merely hardware, but mostly the former is a preferable embodiment. Based on this understanding, the technical solution of the present disclosure may be substantially embodied in a software product or a part of the technical solution that contributes to the prior art may be embodied in a software product, and the computer software can be stored in the storage medium which may be a floppy disk, a Read-only Memory, a Random Access Memory, a Flash, a hard disk, an optical disk and the like, instructions included in the software product are configured to instruct a computer device (such as a personal computer, a server or a network device) to execute the method described in the embodiments of the present invention. A storage medium including computer-executable instructions is provided by the present disclosure, where the computer-executable instructions are configured to perform an information viewing method when being executed by a computer processor, and the method comprises: sending, by a first server, an interactive message comprising a searching instruction to a second server when receiving the searching instruction sent by a client, and the searching instruction contains user information; searching for, by the second server, corresponding target information according to a configured searching permission corresponding to the user information in the searching instruction, generating a searching link address associated with a storage address of the target information and sending the generated searching link address to the first server; returning, by the first server, the searching link address to the client; and presenting, by the second server, the corresponding target information when receiving a viewing request, and the viewing request is generated according to an access request that is initiated by the client according to the searching link address.

For example, the disclosed methods can be implemented by device(s), terminal(s), and server(s) each including one or more processor, and a non-transitory computer-readable storage medium having instructions stored thereon. The instructions can be executed by the one or more processors thereof to implement the methods disclosed herein. In some cases, the instructions can include one or more modules corresponding to the disclosed methods.

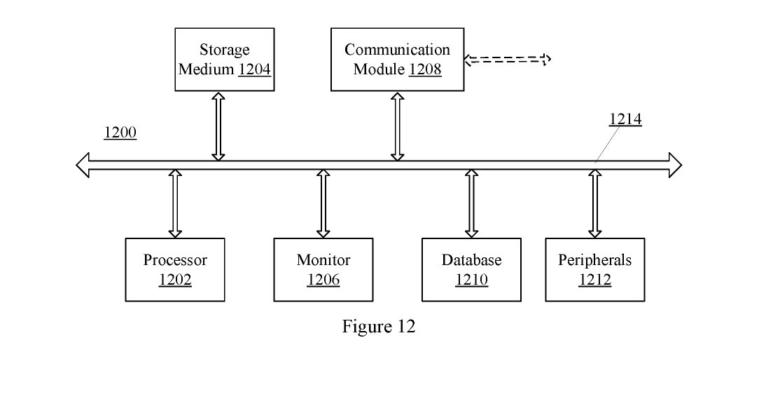

In various embodiments, the device(s), terminal(s), server(s), and/or various modules/units disclosed herein may be implemented using one or more computing systems. FIG. 12 illustrates an exemplary computing system.

As shown in FIG. 12, a computing system 1200 may include a processor 1202, a storage medium 1204, a monitor 1206, a communication module 1208, a database 1210, peripherals 1212, and one or more bus 1214 to couple the devices together. Certain devices may be omitted and other devices may be included.

Processor 1202 can include any appropriate processor or processors. Further, processor 1202 can include multiple cores for multi-thread or parallel processing. Storage medium 1204 may include memory modules, such as ROM, RAM, and flash memory modules, and mass storages, such as CD-ROM, U-disk, removable hard disk, etc. Storage medium 1204 may store computer programs for implementing various processes, when executed by processor 1202.

Further, peripherals 1212 may include I/O devices such as keyboard and mouse, and communication module 1208 may include network devices for establishing connections through the communication network 1102. Database 1210 may include one or more databases for storing certain data and for performing certain operations on the stored data, such as webpage browsing, database searching, etc.

The processor(s) 1202 can upload executable files corresponding to processes of one or more programs/instructions to the storage medium 1204, such as a non-transitory storage medium. The processor(s) 1202 can then be used to run these one or more programs stored in the storage medium 1204. For example, the processor(s) 1202 can cause the exemplary device to perform disclosed information viewing methods.

The embodiments described above are preferable embodiments, and not the limitations to the protection scope of the present disclosure, thus any equivalent alterations made to the claims in the present description are included in the protection scope of the present disclosure.

1. An information viewing method, comprising:
sending, by a first server, an interactive message comprising a searching instruction to a second server when receiving the searching instruction sent by a client, wherein the searching instruction contains user information;
searching for, by the second server, corresponding target information according to a configured searching permission corresponding to the user information in the searching instruction, generating a searching link address associated with a storage address of the target information and sending the generated searching link address to the first server;
returning, by the first server, the searching link address to the client; and
presenting, by the second server, the corresponding target information when receiving a viewing request, wherein the viewing request is generated according to an access request that is initiated by the client according to the searching link address.

2. The method according to claim 1, wherein the sending by the first server the interactive message comprising the searching instruction to the second server when receiving the searching instruction sent by the client comprises:
performing, by the first server, identity verification on the user information in the searching instruction when receiving a message comprising the searching instruction that is sent by the client based on a user login account; and
sending, by the first server, an interactive message comprising the searching instruction to the second server if the identity verification on the user information is passed.

3. The method according to claim 1, wherein the searching for, by the second server, corresponding target information according to the configured searching permission corresponding to the user information in the searching instruction, generating the searching link address associated with the storage address of the target information and sending the generated searching link address to the first server comprises:
searching for and determining, by the second server, the configured searching permission corresponding to the user information in the searching instruction according to preset searching permission configuration information;
searching for, by the second server, the corresponding target information in the scope of the determined searching permission;
generating, by the second server, the searching link address and establishing an association relationship between the searching link address and the storage address of the target information; and
sending, by the second server, the searching link address to the first server.

4. The method according to claim 1, wherein the corresponding target information searched out according to the configured searching permission corresponding to the user information in the searching instruction comprises:
personal private information registered and stored for the user information in the second server; or
internal confidential information that is registered and stored in the second server and available for searching by a user corresponding to the user information.

5. The method according to claim 4, wherein the viewing request is generated by a third server, and before the corresponding target information is presented by the second server upon receiving the viewing request, the method comprises:
triggering and initiating, by the second server, a web function of the third server;
receiving, by the third server, the access request initiated by the client according to the searching link address; and
generating, by the third server, the viewing request according to the access request and sending the viewing request to the second server.

6. The method according to claim 5, wherein the method further comprises:
deleting, by the second server, the association relationship between the searching link address and the storage address of the target information when the second server detects that a presenting duration of the target information reaches a presenting duration threshold;
or,
controlling, by the second server, the third server to shut down the web function when the second server detects that a presenting duration of the target information reaches a presenting duration threshold;
or,
deleting, by the second server, the association relationship between the searching link address and the storage address of the target information after the second server receives the viewing request and presents the corresponding target information.

7. The method according to claim 5, wherein the method comprises:
performing, by the second server, a response limitation process on the target information according to a preset operation response strategy; wherein the preset operation response strategy comprises a strategy of refusing to respond to a copy request from the client, a strategy of refusing to respond to a right-click menu request from the client and a strategy of blocking web spiders from a searching engine.

8. The method according to claim 5, wherein the presenting, by the second server, the corresponding target information upon receiving the viewing request comprises:
receiving, by the second server, the viewing request;
presenting, by the second server, a login interface to the client and receiving inputted user authentication information, and verifying the inputted authentication information; and
displaying, by the second server, the target information corresponding to the storage address according to the association relationship between the searching link address and the storage address of the target information if the verification of the inputted authentication information is passed.

9. The method according to claim 8, wherein the displaying by the second server the target information comprises:
stamping, by the second server, a watermark comprising a user identifier from the authentication information onto the target information to be displayed and displaying the target information with the stamped watermark.

10-16. (canceled)

17. An information viewing device, comprising:
a verifying module, configured to perform identity verification on user information contained in a searching instruction when a message comprising the searching instruction sent by a client based on a user login account is received;
an obtaining module, configured to obtain a searching link address if the identity verification on the user information is passed, wherein the searching link address is associated with a storage address of target information searched out according to the searching instruction; and
a responding module, configured to return the searching link address to the client to allow the client to view the target information through the client according to the searching link address.

18. The device according to claim 17, wherein the obtaining module comprises:
a sending unit, configured to send the interactive message comprising the searching instruction to a searching server if the identity verification on the user information is passed; and
a receiving unit, configured to receive the searching link address returned by the searching server, wherein the searching link address is generated by the searching server according to the target information searched out in response to the searching instruction and the storage address of the target information.

19. An information viewing device, comprising:
a receiving module, configured to receive an interactive message comprising a searching instruction sent by a communication server, wherein the searching instruction contains user information;
a processing module, configured to search for corresponding target information according to a configured searching permission corresponding to the user information in the searching instruction, generating a searching link address associated with a storage address of the target information and sending the searching link address to the communication server such that the communication server returns the searching link address to a client sending the searching instruction; and
a presenting module, configured to present the corresponding target information when a viewing request is received, wherein the viewing request is generated according to an access request that is initiated by the client according to the searching link address.

20. The device according to claim 19, wherein the processing module comprises:
a permission searching unit, configured to search for and determine the configured searching permission corresponding to the user information in the searching instruction according to preset searching permission configuration information;
a searching unit, configured to search for corresponding target information in the scope of the determined searching permission;
a generating unit, configured to generate a searching link address and establish an association relationship between the searching link address and the storage address of the target information; and
a returning unit, configured to send the searching link address to the communication server.

21. The device according to claim 19, wherein the presenting module comprises:
a receiving unit, configured to receive a viewing request initiated by a client according to the searching link address;
a verification unit, configured to present a login interface to the client and receive inputted user authentication information, and verify the inputted authentication information; and
a displaying unit, configured to display the target information corresponding to the storage address according to the association relationship between the searching link address and the storage address of the target information if the verification on the inputted authentication information is passed.

22. The device according to claim 21, wherein
the displaying unit is configured to stamp a watermark comprising a user identifier from the authentication information of the user onto the target information to be displayed and displaying the target information with the stamped watermark when the target information corresponding to the storage address is displayed.

23-25. (canceled)
